(19) United States
(12) Patent Application Publication
(10) Pub. No.: US 2020/0347867 A1
(43) Pub. Date: Nov. 5, 2020

(54) HIGH LOAD FASTENER

(71) Applicant: Kwikbolt Limited, Isleworth (GB)

(72) Inventor: Jan Niklewicz, Kingston Upon Thames (GB)

(73) Assignee: Kwikbolt Limited, Isleworth (GB)

(21) Appl. No.: 16/754,557

(22) PCT Filed: Sep. 6, 2018
(86) PCT No.: PCT/IB2018/056794

§ 371 Date: Apr. 8, 2020

(30) Foreign Application Priority Data
Oct. 9, 2017 (GB) 1716518.4

(51) Int. Cl. F16B 19/10

(52) U.S. Cl. CPC F16B 19/109

(57) ABSTRACT

A fastener includes a hollow tubular body, a hollow leg member translatable within the body having a plurality of resilient legs each with a head at the distal end for engaging with a work-piece. The fastener also includes an actuating member for biasing the resilient legs, where the actuating member includes a profiled tip, the profile of the tip includes a ramp for expanding the legs and a stop, and the stop and legs are arranged such that the stop can engage with an end surface of the legs to draw the legs further into the body and not bias the legs radially outward.

### BACKGROUND

### Field of the Invention

The invention is in the field of fasteners for use in clamping components, where the fastener is removable and may be used in apertures where it is not possible to access the reverse of the components. The fastener is particularly suitable in applications where a high clamping load is required.

### Description of Related Art

Temporary fasteners are used during the fabrication of complex structures such as aircraft frames to align components before permanent fasteners are installed. The number and location of the temporary fastenings will vary between applications, but for a typical wing set, i.e. two complete wings, for a large commercial passenger aircraft, the number of temporary fastenings used can reach around 25,000. It is convenient for such temporary fasteners to be operated from one side of the work-piece only, i.e. to insert and activate the fastener from above the work-piece without having to hold a part of the fastener from the underside of the work-piece, as would be the case for a nut and bolt, because often it is not possible to access both sides of the pieces being clamped simultaneously. Fasteners that operate from one side are called “blind” fasteners and they typically have a threaded part that carries a set of expandable legs, for example EP2247862B; the legs have protruding heads for applying the clamping load and the legs can be expanded when inserted into an aperture and drawn towards the work-piece by rotation of the threaded part until the desired clamping load is achieved.

A known fastener, WO2004/037483, has expanding legs that are drawn into a body by a bulbous element. The ends of the legs have a concave interior to match the convex exterior of the bulbous tip and this ball and socket design allows for misalignment of two surfaces to be clamped.

Some parts of the structure being assembled may require high clamping loads because of their size or because it is not possible to use a large number of less loaded fasteners. A problem with prior art fasteners is that these high clamping loads put a lot of stress on the threads and heads of conventional fasteners and this limits the maximum clamping load for the fastener. Also high clamping loads applied to prior art fasteners, for example WO2004/037483, can damage the structure being clamped because the legs produce an outward radial force against the structure when clamping. It is an object of the invention to overcome the limitations of known fasteners.

### SUMMARY OF THE INVENTION

In an embodiment of the invention, a fastener is provided comprising; a hollow tubular body with a proximal end and a distal end and a central axis, the fastener comprising a hollow leg member having a proximal end and a distal end, the leg member being translatable within the body along the central axis of the body, the leg member having a plurality of resilient legs at the distal end and wherein each leg has a head at the distal end for engaging with a work-piece, the fastener further comprising an actuating member with a proximal end and a distal end for biasing the resilient legs, wherein the actuating member comprises a profiled tip at the distal end and a threaded part, the fastener further comprising a bolt having a proximal end and a distal end, with a threaded part at the distal end for engaging with the threaded part of the actuating member, such that rotation of the bolt in one direction causes the actuating member to be drawn further into the body and bias the legs radially outward, wherein the profile of the tip includes a ramp for expanding the legs and a stop, wherein the stop and legs are arranged such that, when the actuating member is being drawn further into the body, the stop engages with an end surface of the legs to draw the legs further into the body and not bias the legs radially outward. In this way, the clamping load is transmitted in an axial direction through the legs into the clamping heads and not in a radial direction, so that the aperture of the work-piece is not stressed and therefore higher clamping loads may be achieved. The stop may be a flat surface perpendicular to the central axis of the fastener and the ends of the legs have a corresponding flat surface perpendicular to the central axis of the fastener. The perpendicular arrangement ensures that there is no radial expansion of the legs and thus the entire clamping load is transmitted axially into the heads to clamp the work-pieces. A shelf region may be provided between the ramp and the stop, wherein the shelf region comprises a cylindrical surface of constant diameter, that does not bias the legs radially outward. The use of a shelf region provides an increased contact surface with the interior surface of the heads and therefore better support during clamping. The cylindrical profile of the shelf region of the actuating tip also does not impart any radial movement to the legs during clamping, thus helping to preserve the integrity of the work-pieces.

The ramp of the tip may be a frusto-conical shape. A resilient means, such as a helical spring, may be provided between the actuator and the leg member and the resilient means selected so that the force required to compress it is greater than the force required to expand the resilient legs. This ensures that the legs are fully expanded before they are drawn into the body.

The legs may have a head with an undercut to prevent damage to the work-piece being clamped.

The actuating member may have an internal thread. The bolt may have an external thread.

The legs and the body may have co-operating anti-rotation features. The anti-rotation feature of the legs may include a series of external profiled surfaces forming a hexagonal shape and the anti-rotation feature of the body may include a series of internal profiled surfaces forming a hexagonal shape.

The bolt may have a shoulder at the proximal end and the body has a shelf and a further retaining means for retaining the bolt within the body.

A cap with an aperture may be provided at the distal end of the body. The leg member may have a lip at the proximal end that is greater in diameter than the aperture in the cap, to retain the leg member.

The legs may include a smooth region suitable for closely fitting into a hole, the smooth region of the legs serving as a dowel for joining components.

### BRIEF DESCRIPTION OF THE DRAWINGS

FIG. 1 is a cross section of the fastener in accordance with an embodiment of the invention.

FIG. 2A is view of the bolt of the fastener shown in FIG. 1.

FIG. 2B is a cross section of the bolt shown in FIG. 2A.

FIG. 3A is view of the tube of the fastener shown in FIG. 1.

FIG. 3B is a cross section of the tube shown in FIG. 3A.

FIG. 4A is view of the actuator tip of the fastener shown in FIG. 1.

FIG. 4B is a cross section of the actuator tip shown in FIG. 4A.

FIG. 5A is view of the leg member of the fastener shown in FIG. 1.

FIG. 5B is a cross section of the leg member shown in FIG. 5A.

FIG. 5C is a close up cross sectional view of the head region of one of the legs shown in FIGS. 5A and 5B.

FIG. 6A is view of the body of the fastener shown in FIG. 1.

FIG. 6B is a cross section of the body shown in FIG. 6A.

FIG. 7A is view of the cap of the fastener shown in FIG. 1.

FIG. 7B is a cross section of the cap shown in FIG. 2A.

FIG. 8 is a cross sectional exploded view of the fastener shown in FIG. 1.

FIG. 9 is a view of the fastener of FIG. 1 ready to be inserted into aligned apertures in work-pieces prior to clamping.

FIG. 10 is a cross sectional view of the end of the fastener being inserted into an aperture in a work-piece.

FIG. 11 is a side view of the fastener being inserted into an aperture in a work-piece.

FIG. 12 is a cross sectional view of the end of the fastener clamping work-pieces.

FIG. 13 is a side view of the fastener clamping work-pieces.

### DETAILED DESCRIPTION OF THE INVENTION

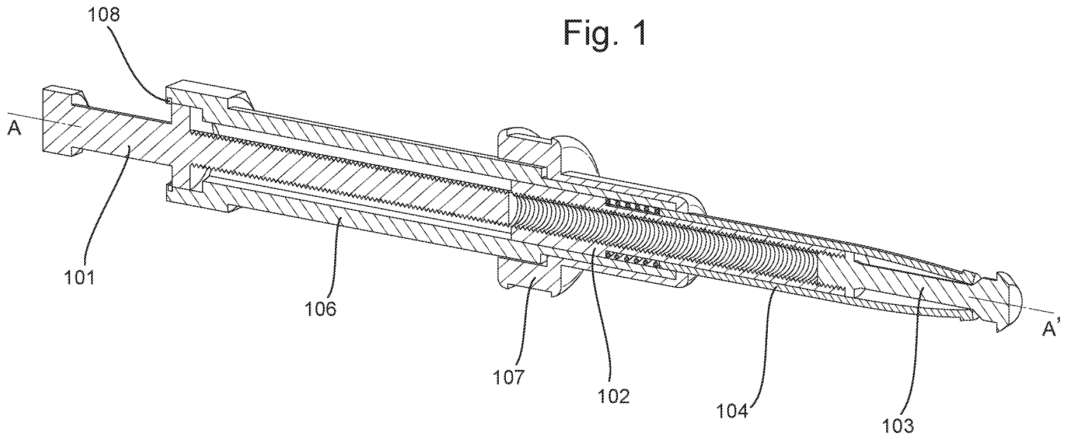

The fastener 100, shown in cross-section in FIG. 1, comprises a bolt 101 having an external threaded section, a tube 102 with an internal thread for engaging with the external thread of the bolt 101, such that rotation of the bolt 101 can cause the tube 102 to move up and down the bolt 101 along the axis AA′. The tube 102 is closed at one end by an actuator tip 103. The assembly of the tube and the actuator tip are collectively referred to as an actuating member in the claims. The tube is free to move within a cylindrical leg member 104 and the leg member is captive between one end of the tube 102 and the actuator tip 103. The assembly of the bolt 101, tube 102, tip 103 and leg member 104 is enclosed in a body 106 with an open end, closed with a cap 107 at one end and a circlip 108 at the other.

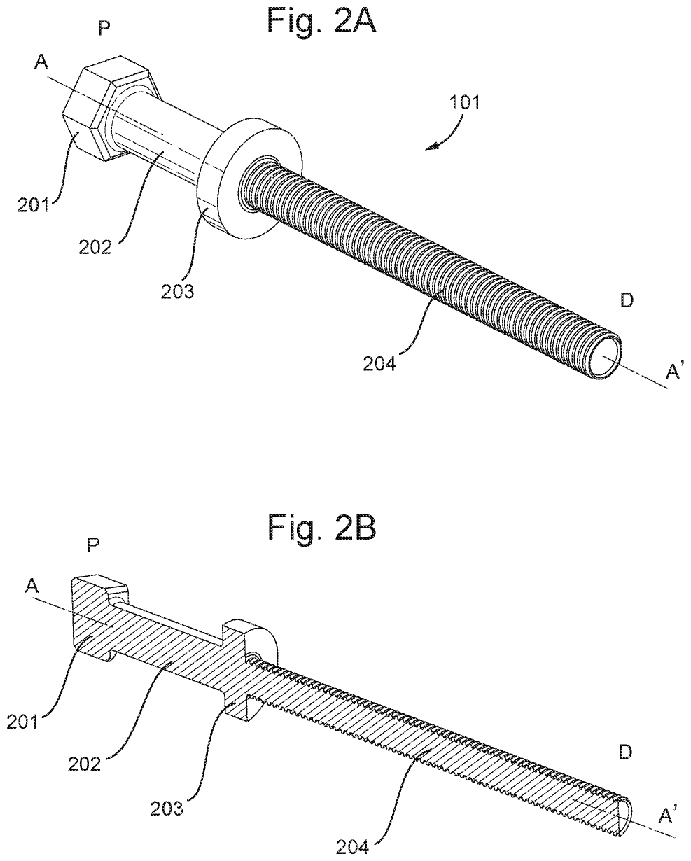

The bolt 101 is shown in more detail in FIGS. 2A and 2B. The bolt 101 is generally a rod having a proximal end P and a distal end D, with four distinct features. The first feature is located at the proximal end and comprises a hex-shaped head 201 suitable for engaging with a tool to rotate the bolt 101 about its central axis AA′. The bolt is preferably fabricated from a single piece of material, with each region being a part of the composite whole. Adjacent to the head 201 is the second feature, a spacer region 202 provided so that the head 201 stands proud of the fastener 100. Adjacent to the spacer region 202 is the third feature, a shoulder 203, comprising a short cylindrical section that is wider than the diameter of the rest of the bolt 101 to provide a flange. Adjacent to the shoulder 203 is the fourth feature, an externally threaded region 204 that comprises most of the bolt 101. The threaded region 204 extends to the distal end D of the bolt 101.

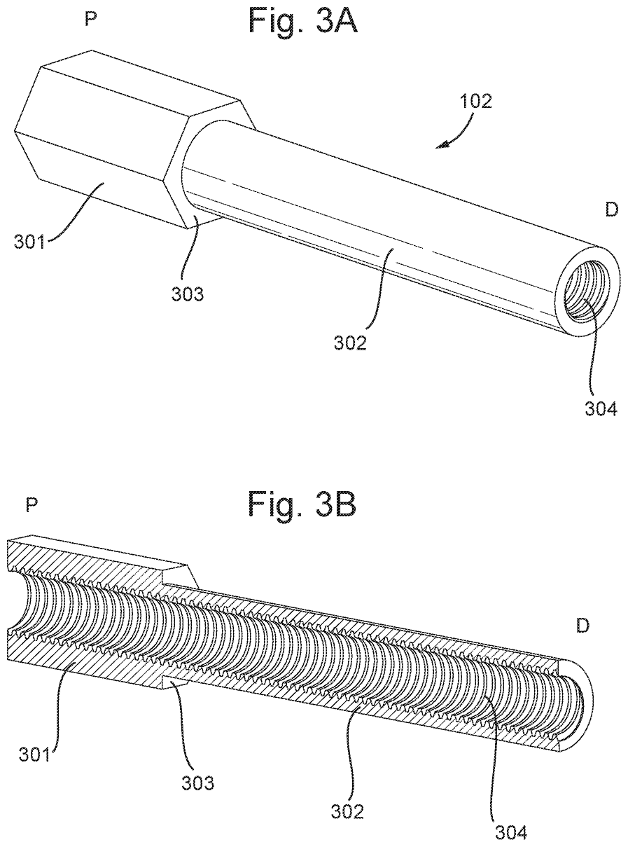

The tube 102 is shown in more detail in FIGS. 3A and 3B. The tube has two regions: an anti-rotation part 301 at a proximal end P, which has an external profile of a set of six parallel planar faces, forming a non-cylindrical hexagonal external profile; and a smooth region 302 at a distal end D having a cylindrical external profile. The diameter of the anti-rotation part 301 is greater than that of the smooth region 302, thus forming a shoulder 303 between the two regions, this acting as a stop in the assembled fastener. The tube 102 has an internal thread 304 running its entire length. The diameter and pitch of the thread 304 is arranged to cooperate with the external threaded region 204 of the bolt 101.

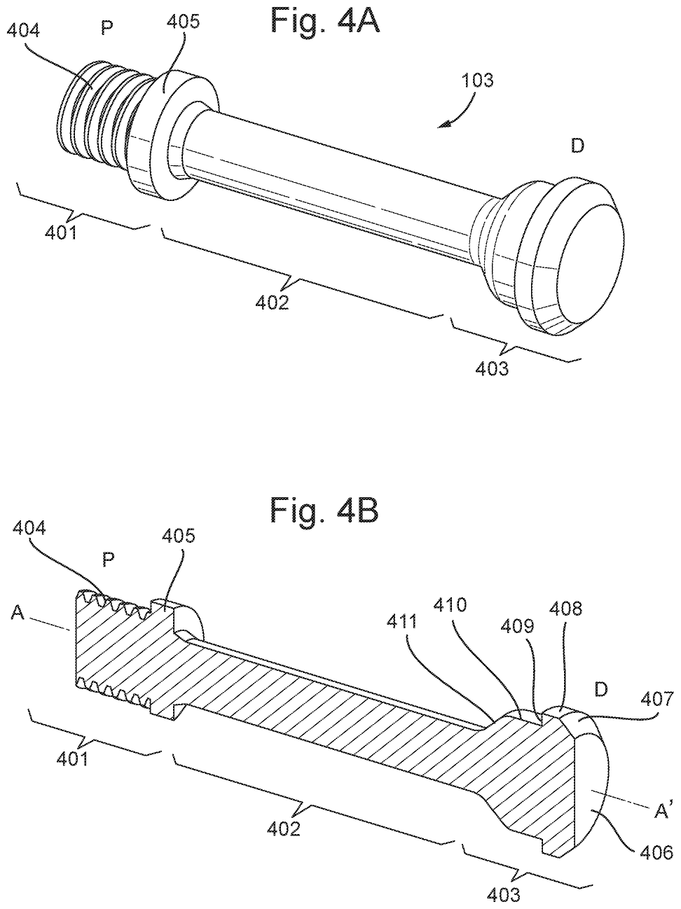

The actuator tip 103 is shown in more detail in FIGS. 4A and 4B. The tip 103 has three regions: a mounting region 401 at a proximal end P; a waist region 402 and a head region 403 at a distal end D. The tip 103 is radially symmetrical about its central axis. The mounting region 401 comprises an externally threaded part 404 having the same diameter and pitch as the internal thread of the tube 102 and a stop 405 having a diameter greater than that of the threaded part 404 of the mounting region 401. The waist region 402 is of smooth cylindrical profile of diameter less than that of the stop 405. The head region 403 includes a number of distinct regions, as shown in more detail in the cross-sectional diagram in FIG. 4B; the regions are rotationally symmetrical around the central axis AA′ of the tip 103. The regions include: a flat end 406 at the distal end of the tip 103; a frustoconical chamfer 407 extending out to a wider rim 408; a stop 409 behind the rim 408; a shelf region 410, formed of a cylindrical surface extending away from the stop 408 towards the proximal end of the tip 103; and a frustoconical ramp 411 forming a gradient to reduce the diameter of the head region 403 to that of the waist region 402.

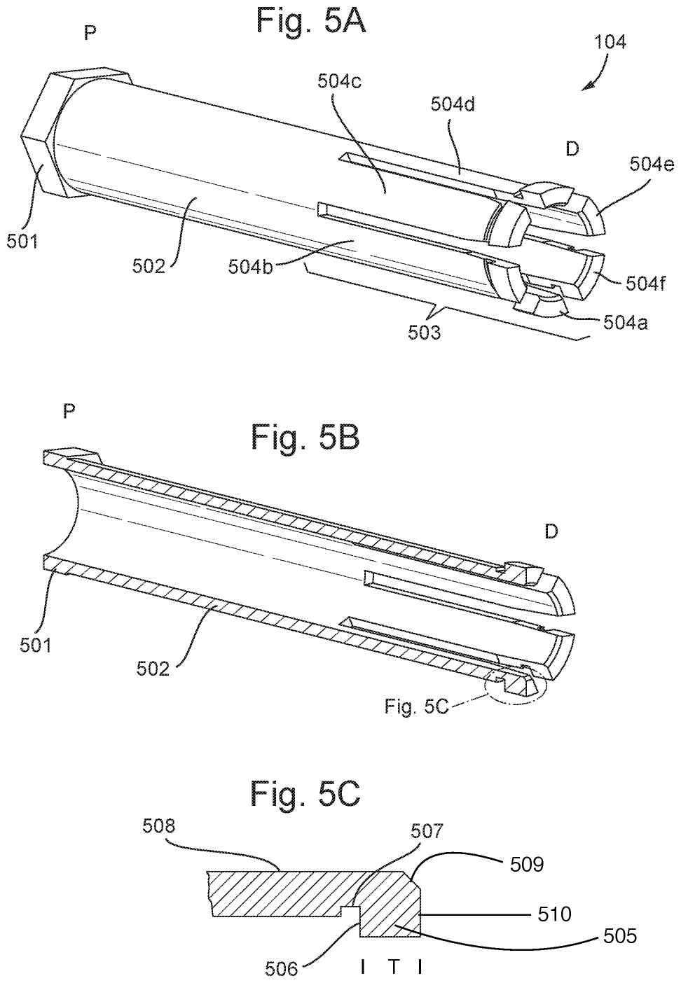

The leg member 104 is shown in more detail in FIGS. 5A and 5B. The leg member 104 is a tubular component with a proximal end P and a distal end D. The leg member consists of an anti-rotation portion 501 at the proximal end, a smooth dowel region 502 and a leg region 503 at the distal end. The anti-rotation portion 501 comprises a series of raised planar faces forming hex-type feature. The dowel region 502 has an internal bore of a constant diameter, which, at rest, tapers becoming narrower in the leg region 503; FIGS. 5A and 5B show the legs in a biased expanded state. The leg member in the at-rest tapered state is shown in FIG. 1. The leg region 503 is provided with a series of parallel slots in the wall of the leg member 104, to form six resilient legs 504a-f. These are formed so that they are tapered inward, so the distal end of the leg region 503 has an equal or smaller diameter than the dowel region 502. The legs 504a-f can be biased radially outwards away from the central axis and are sprung so that when the legs are deformed radially outward they can spring back to their original position, allowing the fastener to be removed and re-used. The external surface of the legs 504a-f also provides a dowelling region for closely fitting into a hole in the components. Each leg 504a-f has a clamping head 505 at its far end, as shown in FIG. 5C. Each clamping head 505 has a clamping face 506 orientated such that it can engage with a surface of the parts to be clamped. A recess 507 is provided to protect the edge of the work-piece being clamped. A chamfer 509 may be provided for engaging with the ramp 411 of the actuator tip 103 and a face 510 for engaging with the stop 409 of the actuator tip. The head of the legs may have a thickness T that is substantially equal to the length of the shelf 410 of the actuator tip. For larger apertures extra legs can be provided to spread the clamping load. The legs have a curved cross section, which increases their strength. Each leg also has an internal actuating face 508. When the legs are in the relaxed state, the bore of the leg member tapers, becoming narrower at the leg section 503 and the actuating faces 508 of each leg taper towards each other. The legs 504a-f are operable between a closed position and an open position; the resting state of the legs 504 is the closed position, where the outside diameter of the clamping head is less than or equal to the outside diameter of the grooved shaft, so that the legs can be inserted into a hole in the parts to be clamped.

The legs 504a-f are arranged to engage with the shelf 410 and stop 409 of the actuator tip 103, as shown in FIG. 12. When the legs 504a-f have been expanded by the ramp 411, the internal surface 508 of the legs rests against the shelf 410, and the face 510 of the legs against the stop 409. In this way, the head of the legs is supported by the actuator tip 103 so that all of the clamping load is transmitted through the stop 409 to the face 510 of the legs and thus to the clamping face 506 and the work-piece; the clamping load is transmitted substantially parallel to the axis of the fastener, which allows high clamping loads to be applied. When the legs are engaged with the shelf and the stop, the legs are no longer expanding and thus the clamping load is not acting in a direction perpendicular to the axis of the fastener. High loads that are transmitted perpendicular to the axis of the fastener while clamping can cause the apertures in the work-pieces being clamped to expand, causing damage.

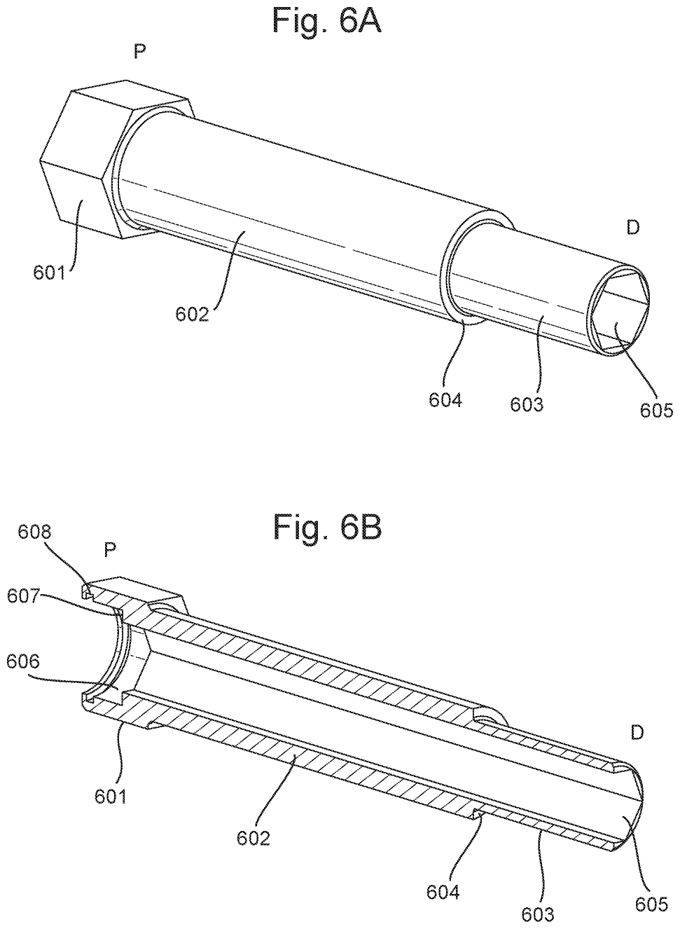

The body 106 of the fastener is shown in more detail in FIGS. 6A and 6B. The body 106 is a tubular component having a proximal end P and a distal end D. At the proximal end a series of planar faces form a hex head 601 for gripping with a tool, such as a spanner. The central part 602 is a cylindrical tube with diameter that is less than the hex head 601. Adjacent to the central part 602 at the distal end of the body 106 is an end 603 of cylindrical shape and of diameter less than the central part 602, providing a shoulder 604 between the central part 602 and the end 603. The internal section 605 of the body 106 is hexagonal along substantially all of its length, except for a receiving portion 606 at the head 601 which is cylindrical and of greater diameter than the section 605, so that a rim 607 is formed between the receiving portion 606 and the internal section 605. The receiving portion 606 also includes an internal recess 608 at the proximal end. The dimensions of the hexagonal internal section 605 are selected so as to receive the anti-rotation portion 501 of the leg member 104.

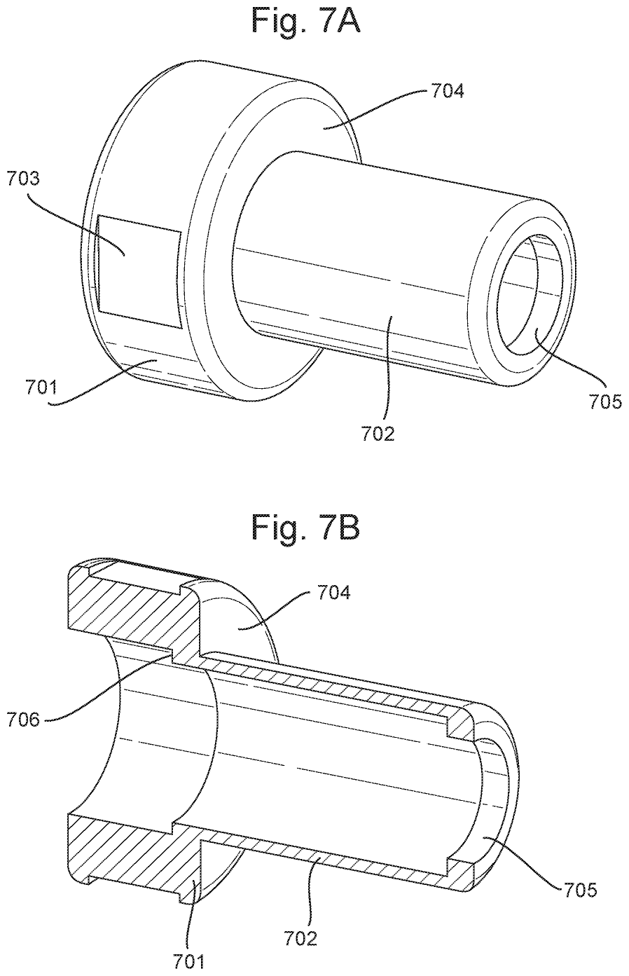

The cap 107 of the fastener is shown in more detail in FIGS. 7A and 7B. The cap has substantially two regions; a shroud region 701 and a dowel region 702. Both the shroud region 701 and dowel regions 702 have substantially cylindrical external surfaces. The shroud region 701 is provided with flattened parts 703 for receiving a tool to install the cap 107 or prevent the fastener from rotating. The dowel region 702 is of a reduced diameter in comparison to the shroud region 701, thus forming an external contact shoulder 704. In use the external contact shoulder 704 is in contact with the surface of a work-piece and provides the opposing reaction force to that of the clamping face 506 of the legs of the leg member 104 when the fastener is clamping. The dowel region 702 provides a way of locating the fastener in an aperture of the work-piece. The dowel region 702 further includes a restriction 705. The cap 107 is hollow and its interior has two regions, being wider in the shroud region 701 than the dowel region 702, thus forming an internal shoulder 706, shown in FIG. 7B. The diameter of the interior of shroud region 701 is selected to be a close fit with the central part 602 of the body 106. The diameter of the interior of the end region 603 of the body 106 is selected to be a close fit with the end part 603 of the body 106. The restriction 705 provides an orifice of reduced diameter in comparison to the interior diameter of dowel region 702. The diameter of the orifice in the restriction 705 is selected to allow passage of the dowel region 502 of the legs, but not the anti-rotation portion 501.

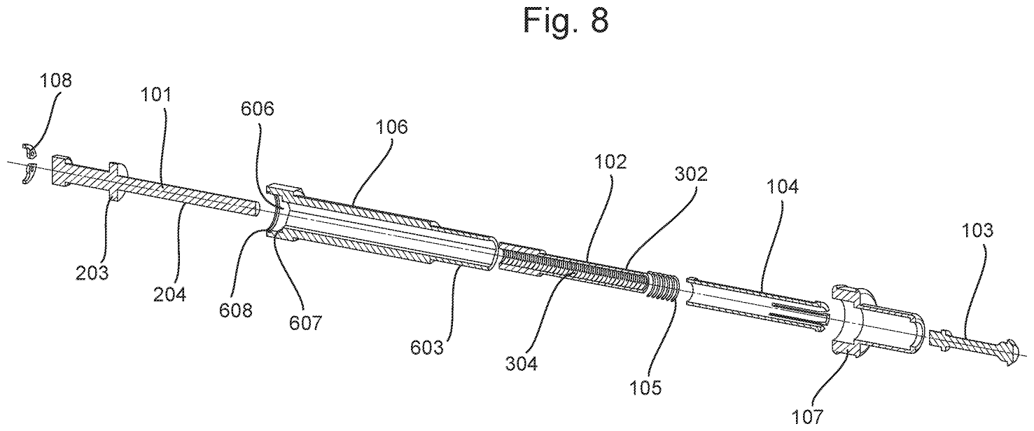

The fastener 100 is assembled as follows and with reference to FIG. 8. The distal end of the bolt 101 is inserted through the proximal end of the body 106 until the shoulder 203 of the bolt 101 contacts the rim 607 in the receiving portion 606 of the body 106. A circlip 108 is installed in the recess 608 of the head 601 of the body 106 to retain the bolt 101 in the body 106. The proximal end of the actuator tip 103 is engaged with the internal thread 304 of the threaded tube 102 by rotation, until the actuator tip 103 is tightly connected to the threaded tube 102. The proximal end of the threaded tube 102 is then inserted into the distal end of the body 106 so that the internal thread 304 of the threaded tube 102 engages with the external thread 204 of the bolt 101, by rotation of the bolt 101, until approximately half of the threaded tube is located within the body 106. A compression spring 105 having an internal diameter substantially equal to the external diameter of the smooth region 302 of the threaded tube 102 and external diameter substantially equal to the internal diameter of the body 106 is placed over the smooth region 302 of the threaded tube 102. The leg member 104 is then slipped over the smooth region 302 of the threaded tube 102 and pushed so that the legs 504a-f expand and slip over the head 403 of the actuator tip 103, so that the legs 504a-f rest against the waist region 402 of the actuator tip 103. The cap 107 is installed over the end 603 of the body 106 to hold the leg member 104 captive within the body 106. The cap may be a push fit or can be fixed with adhesive. The complete fastener is then ready for use.

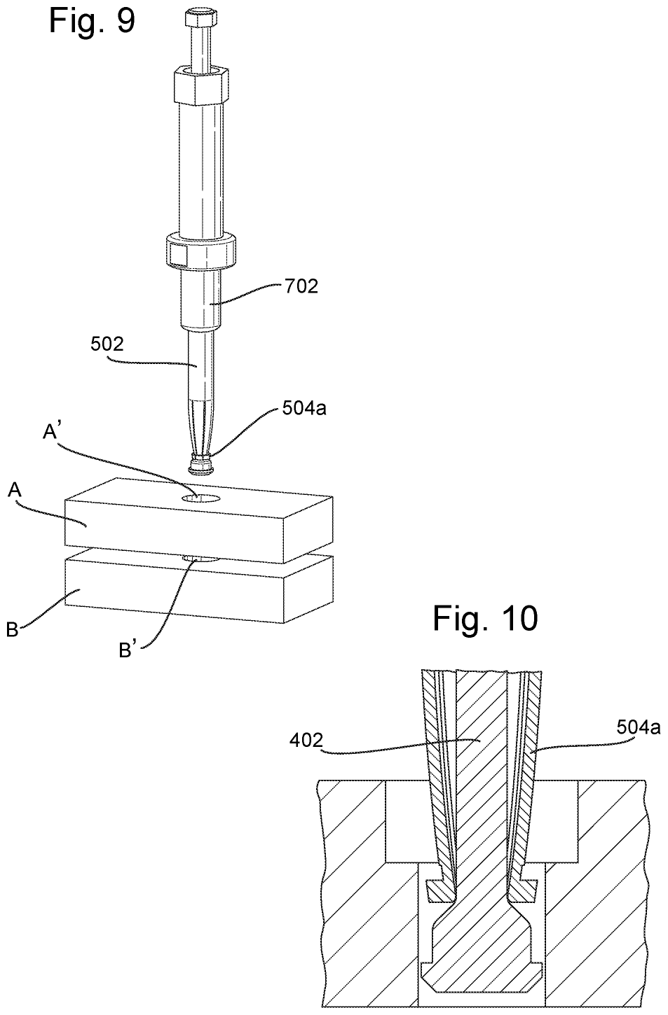

The fastener 100 is used to clamp together work-pieces that have been pre-prepared with aligned apertures, as shown in FIG. 9. Uppermost work-piece A, which is for example a section of wing covering, is pre-drilled with an aperture A′, of a diameter that is a close fit to the dowel region 702 of the cap 107. The lower work-piece B, for example a wing spar, may be pre-drilled with a two-step aperture B′ where the upper aperture has a diameter that is a close fit to the dowel region 702 of the cap 107 and the lower part is of a reduced diameter that is a close fit to the dowel region 502 of the leg member 104. A two-step aperture arrangement would be used for example if work-piece A is a jigging plate deployed for the manual drilling of the composite/metal parts.

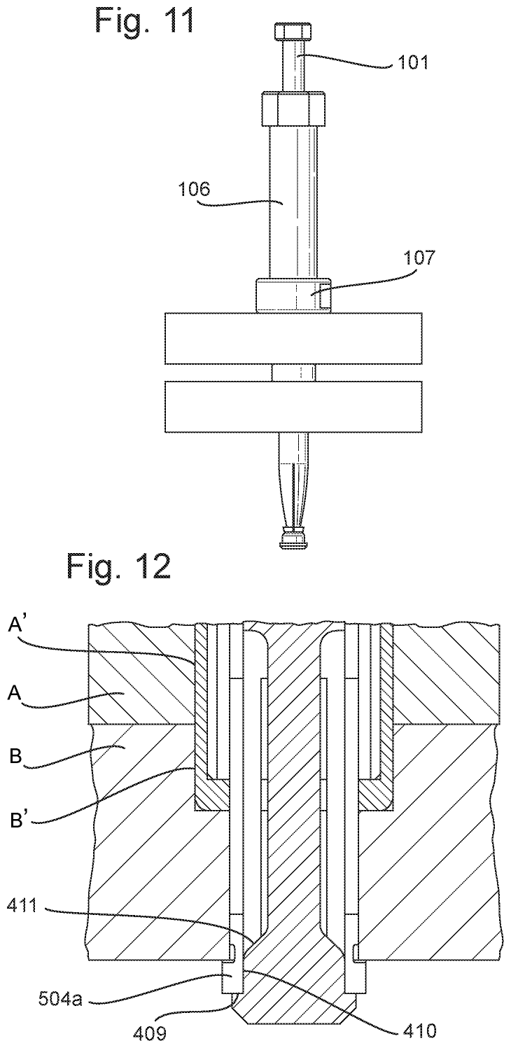

Alternatively, the two apertures A′, B′ may be of the same diameter, then the cap used would be short and sit flush with the top surface of work-piece A. In the insertion state, the legs 504a-f are tapered inwards and rest against the waist region 402 of the actuator tip 103, as shown in FIG. 10, so that the fastener 100 may be inserted through both apertures, A′ and B′. The fastener 100 is passed through the aligned apertures until the contact shoulder 704 is in contact with the upper face of the work-piece A, as shown in FIG. 11. Clamping of the work-pieces is effected by holding the hex-head 601 of the body 106 with a tool, such as a spanner, to prevent the fastener 100 rotating, and simultaneously rotating the bolt 101, by engaging a tool with the hex-head 201 at the proximal end of the bolt 101. Rotation of the bolt causes the threaded tube 102 to travel in an axial direction towards the proximal end of the body 106, as the thread 204 of the bolt 101 is engaged with the thread of the tube 102, and the tube 102 is prevented from rotating by its hex profiled anti-rotation part 301 engaging with the hex profiled interior of the body 106.

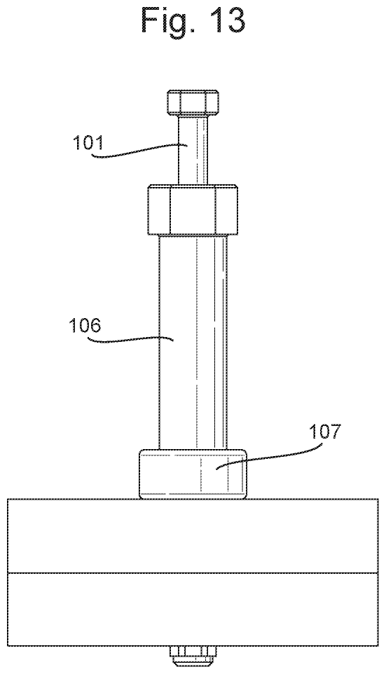

As the tube 102 is drawn into the body, the actuator tip 103 passes through the legs 504a-f until the ramp 411 is in contact with the end of the legs. As the bolt 101 is further rotated and the tube 102 and tip 103 assembly is drawn further into the body 106 of the fastener, the legs 504a-f engage with the ramp 411 of the actuator tip 103 and are caused to spread open. The compression load of the spring 105 is selected so that the legs preferentially spread open before the spring 105 compresses, i.e. the resilience of the spring 105 is greater than that of the legs combined. Further rotation of the bolt 101 causes the ramp 411 of the tip 103 to draw past the end of the legs 504a-f so that the end of the legs become located on the shelf region 410 of the tip and cease to expand outwards; the legs reach their maximum expansion, which is now wider than the narrower part of aperture B′. Eventually the stop 409 on the tip 103 reaches the end of the legs 504a-f, as shown in FIG. 12. At this point, further rotation of the bolt 101 causes the entire leg member 104 to retract into the body 106 as the spring 105 compresses. This movement of the legs towards the body continues and the clamping face 506 of the legs 504a-f contacts the underside of work-piece B, drawing the two work-pieces together, until the desired clamping load is reached. The fastener in a fully clamped state is shown in FIG. 13.

Extraction of the fastener is the reverse procedure to insertion, i.e. the bolt 101 is rotated in the opposite direction, which causes the tube 102 to move away from proximal end of the body 106. As the tip 103 moves outward, the spring 105 urges the leg member 104 out of the body 106 and thus releases the clamping load from the work-pieces. The fastener can be removed when the legs 504a-f relax to their original tapered position, as the bolt 101 is further rotated, causing the tube 102 and tip 103 to move outwards and thus the ramp 411 to slide past the legs.

All of the components of the fastener are produced from high strength steel. The leg member is produced by an additive technique, such as 3D printing. The legs of the leg member are printed in the expanded position, and then heat-treated manipulated into the tapered position, so that at rest the legs are tapered.

An advantage of this configuration is that, unlike other fasteners, the legs will not damage the work-piece, either the planar face of the work-piece or the aperture, which is critical in aerospace applications, where even small cracks or scratches can provide a site for such defects to grow, with catastrophic consequences. Damage to the work-pieces is avoided because the legs open to their full extent before the clamping face 506 of the legs engages with the work-piece. The shelf-region 410 provides a non-expanding zone for the legs and its diameter determines the maximum extent of leg expansion, while the stop 409 provides a point at which the legs start retracting into the body of the fastener.

A further advantage of the configuration of the tip retraction assembly, i.e. the bolt 101, tube 102 and tip 103, is that the fastener is a sealed unit, i.e. that the shoulder 203 of the bolt 101 closes off the interior of the body 106, which can prevent ingress of debris that would otherwise damage the fastener. The external thread of the bolt facilitates this sealed arrangement.

Typical dimensions of the fastener are for the leg member to be between 5 mm to 25 mm diameter and between 4-8 cm in length. Clamping loads of between 2,000N to 50,000 N respectively can be achieved.

Other arrangements of the shelf and stop of the actuator tip may be envisaged that also have the same effect, i.e. preventing expansion of the legs while they are being drawn into the body by the tip. For example, the shelf region may be omitted, so that the tip has only a ramp and a stop. Alternatively, the stop may be angled inward toward the proximal end of the actuator tip and the end face 510 of the legs angled to match, so that the stop catches the legs after they have been expanded by the ramp.

I claim:

1. A fastener comprising;
a hollow tubular body (106) with a proximal end and a distal end and a central axis,
the fastener comprising a hollow leg member (104) having a proximal end and a distal end, the leg member (104) being translatable within the body along the central axis of the body 106, the leg member (104) having a plurality of resilient legs (504a-f) at the distal end and wherein each leg has a head at the distal end for engaging with a work-piece,
the fastener further comprising an actuating member with a proximal end and a distal end for biasing the resilient legs (504a-f), wherein the actuating member comprises a profiled tip (103) at the distal end and a threaded part (102), the fastener further comprising a bolt (101) having a proximal end and a distal end, with a threaded part (204) at the distal end for engaging with the threaded part (102) of the actuating member, such that rotation of the bolt (101) in one direction causes the actuating member to be drawn further into the body (106) and bias the legs (504a-f) radially outward,
characterised in that the profile of the tip (103) includes a ramp (411) for expanding the legs and a stop (409), wherein the stop and legs are arranged such that, when the actuating member is being drawn further into the body, the stop (409) engages with an end surface (510) of the legs to draw the legs further into the body and not bias the legs radially outward.

2. A fastener in accordance with claim 1, wherein the stop (409) of the actuating member includes a flat surface perpendicular to the central axis of the fastener and the ends of the legs have a corresponding flat surface (506) perpendicular to the central axis of the fastener.

3. A fastener in accordance with claim 1, wherein a shelf region is provided between the ramp and the stop, wherein the shelf region (410) comprises a cylindrical surface of constant diameter, that does not bias the legs radially outward.

4. A fastener in accordance with claim 1, wherein the ramp (411) of the tip is a frusto-conical shape.

5. A fastener in accordance with claim 1, wherein resilient means (105), such as a helical spring, is provided between the actuator and the leg member.

6. A fastener in accordance with claim 5, wherein the resilient means is selected so that the force required to compress the resilient means is greater than the force required to expand the resilient legs.

7. A fastener in accordance with claim 1, wherein each head of the legs has an undercut (507) near the head.

8. A fastener in accordance with claim 1, wherein the actuating member has an internal thread (304).

9. A fastener in accordance with claim 1, wherein the bolt has an external thread (204).

10. A fastener in accordance with claim 1, wherein the legs and the body have co-operating anti-rotation features (605,501).

11. A fastener in accordance with claim 10, wherein the anti-rotation feature of the legs include a series of external profiled surfaces (501) forming a hexagonal shape and the anti-rotation feature of the body include a series of internal profiled surfaces (605) forming a hexagonal shape.

12. A fastener in accordance with claim 1, wherein the bolt has a shoulder (203) at the proximal end and the body has a shelf (607) and a further retaining means (108) for retaining the bolt within the body.

13. A fastener in accordance with claim 1, wherein a cap (107) with an aperture (705) is provided at the distal end of the body.

14. A fastener in accordance with claim 1, wherein the leg member (104) has a lip at the proximal end that is greater in diameter than the aperture in the cap, to retain the leg member.

15. A fastener in accordance with claim 1, wherein the legs include a smooth region (502) suitable for closely fitting into a hole, the smooth region of the legs serving as a dowel for joining components.
